(19) United States
(12) Patent Application Publication
(10) Pub. No.: US 2013/0051633 A1
(43) Pub. Date: Feb. 28, 2013

(54) IMAGE PROCESSING APPARATUS

(71) Applicant: Masayoshi OKAMOTO, Daito-shi (JP)

(72) Inventor: Masayoshi OKAMOTO, Daito-shi (JP)

(73) Assignee: SANYO ELECTRIC CO., LTD., Osaka (JP)

(21) Appl. No.: 13/584,093

(22) Filed: Aug. 13, 2012

(30) Foreign Application Priority Data
Aug. 26, 2011 (JP) 2011-185025

(51) Int. Cl. G06K 9/62

(52) U.S. Cl. 382/118

(57) ABSTRACT

An image processing apparatus includes a searcher. A searcher searches for a face image representing a face portion of a target person from a designated image, in response to an operation of an operator. A definer defines an expression of the face image detected by the searcher in a manner different depending on a race of the target person and/or a race of the operator. A processor performs on the designated image an output process different depending on the expression defined by the definer.

### CROSS REFERENCE OF RELATED APPLICATION

The disclosure of Japanese Patent Application No. 2011-185025, which was filed on Aug. 26, 2011, is incorporated herein by reference.

### BACKGROUND OF THE INVENTION

1. Field of the Invention

The present invention relates to an image processing apparatus, and in particular, relates to an image processing apparatus which has a function of detecting emotions of a target person.

2. Description of the Related Art

According to one example of this type of apparatus, a vibration of the diaphragm of an examinee is detected by a detector. It is determined whether or not the examinee smiles based on the detected data. It becomes possible to detect an unvoiced small smile by determining based on the detected data of the vibration of the diaphragm which is a physical direct motion of a smile.

However, in the above-described apparatus, the detected data is not reflected in an image output process, and therefore, an output performance is limited.

### SUMMARY OF THE INVENTION

An image processing apparatus according to the present invention comprises: a searcher which searches for a face image representing a face portion of a target person from a designated image, in response to an operation of an operator; a definer which defines an expression of the face image detected by the searcher in a manner different depending on a race of the target person and/or a race of the operator; and a processor which performs on the designated image an output process different depending on the expression defined by the definer.

According to the present invention, an image processing program recorded on a non-transitory recording medium in order to control an image processing apparatus, the program causing a processor of the image processing apparatus to perform the steps comprises: a searching step of searching for a face image representing a face portion of a target person from a designated image, in response to an operation of an operator; a defining step of defining an expression of the face image detected by the searching step in a manner different depending on a race of the target person and/or a race of the operator; and a processing step of performing on the designated image an output process different depending on the expression defined by the defining step.

According to the present invention, an image processing method executed by an image processing apparatus, comprises: a searching step of searching for a face image representing a face portion of a target person from a designated image, in response to an operation of an operator; a defining step of defining an expression of the face image detected by the searching step in a manner different depending on a race of the target person and/or a race of the operator; and a processing step of performing on the designated image an output process different depending on the expression defined by the defining step.

The above described features and advantages of the present invention will become more apparent from the following detailed description of the embodiment when taken in conjunction with the accompanying drawings.

### BRIEF DESCRIPTION OF THE DRAWINGS

FIG. 1 is a block diagram showing a basic configuration of one embodiment of the present invention;

FIG. 2 is a block diagram showing a configuration of one embodiment of the present invention;

FIG. 3(A) is an illustrative view showing one example of a configuration of a destination information register;

FIG. 3(B) is an illustrative view showing one example of a configuration of a camera-owner information register;

FIG. 3(C) is an illustrative view showing one example of a configuration of a person information register;

FIG. 4(A) is an illustrative view showing one example of a registered-person menu;

FIG. 4(B) is an illustrative view showing one example of a reproduction-order menu;

FIG. 5 is an illustrative view showing one example of a configuration of a search list;

FIG. 6(A) is an illustrative view showing one example of image data;

FIG. 6(B) is an illustrative view showing another example of the image data;

FIG. 6(C) is an illustrative view showing still another example of the image data;

FIG. 6(D) is an illustrative view showing yet another example of the image data;

FIG. 6(E) is an illustrative view showing another example of the image data;

FIG. 7(A) is an illustrative view showing one portion of the image data shown in FIG. 6(A);

FIG. 7(B) is an illustrative view showing one portion of the image data shown in FIG. 6(B);

FIG. 7(C) is an illustrative view showing one portion of the image data shown in FIG. 6(C);

FIG. 7(D) is an illustrative view showing one portion of the image data shown in FIG. 6(D);

FIG. 7(E) is an illustrative view showing one portion of the image data shown in FIG. 6(E);

FIG. 8(A) is an illustrative view showing still another example of the image data;

FIG. 8(B) is an illustrative view showing yet another example of the image data;

FIG. 8(C) is an illustrative view showing another example of the image data;

FIG. 8(D) is an illustrative view showing still another example of the image data;

FIG. 8(E) is an illustrative view showing yet another example of the image data;

FIG. 9(A) is an illustrative view showing one portion of the image data shown in FIG. 8(A);

FIG. 9(B) is an illustrative view showing one portion of the image data shown in FIG. 8(B);

FIG. 9(C) is an illustrative view showing one portion of the image data shown in FIG. 8(C);

FIG. 9(D) is an illustrative view showing one portion of the image data shown in FIG. 8(D);

FIG. 9(E) is an illustrative view showing one portion of the image data shown in FIG. 8(E);

FIG. 10(A) is a graph showing one example of a relationship between a smile degree and a deformation amount of an eyes region;

FIG. 10(B) is a graph showing one example of a relationship between the smile degree and a deformation amount of a mouth region;

FIG. 11 is a flowchart showing one portion of behavior of a CPU applied to the embodiment in FIG. 2;

FIG. 12 is a flowchart showing another portion of behavior of the CPU applied to the embodiment in FIG. 2;

FIG. 13 is a flowchart showing still another portion of behavior of the CPU applied to the embodiment in FIG. 2;

FIG. 14 is a flowchart showing yet another portion of behavior of the CPU applied to the embodiment in FIG. 2;

FIG. 15 is a flowchart showing another portion of behavior of the CPU applied to the embodiment in FIG. 2;

FIG. 16 is a flowchart showing still another portion of behavior of the CPU applied to the embodiment in FIG. 2;

FIG. 17 is a flowchart showing yet another portion of behavior of the CPU applied to the embodiment in FIG. 2; and

FIG. 18 is a block diagram showing a basic configuration of another embodiment of the present invention.

### DETAILED DESCRIPTION OF THE PREFERRED EMBODIMENTS

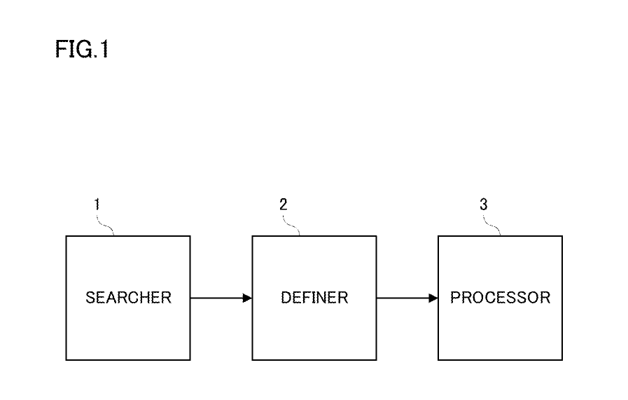

With reference to FIG. 1, an image processing apparatus according to one embodiment of the present invention is basically configured as follows: A searcher 1 searches for a face image representing a face portion of a target person from a designated image, in response to an operation of an operator. A definer 2 defines an expression of the face image detected by the searcher 1 in a manner different depending on a race of the target person and/or a race of the operator. A processor 3 performs on the designated image an output process different depending on the expression defined by the definer 2.

When the expression of the face of the target person is changed corresponding to emotions of the target person, a manner of a change is different depending on a race of the target person. Moreover, emotions of the target person received from a change of the expression of the face by an observer who observes the target person are different depending on a race of the observer.

Then, in this embodiment, the expression of the face image of the target person is defined in a manner different depending on the race of the target person and/or the race of the operator, and the output process different depending on the defined expression is performed on the designated image. Thereby, an image output performance is improved.

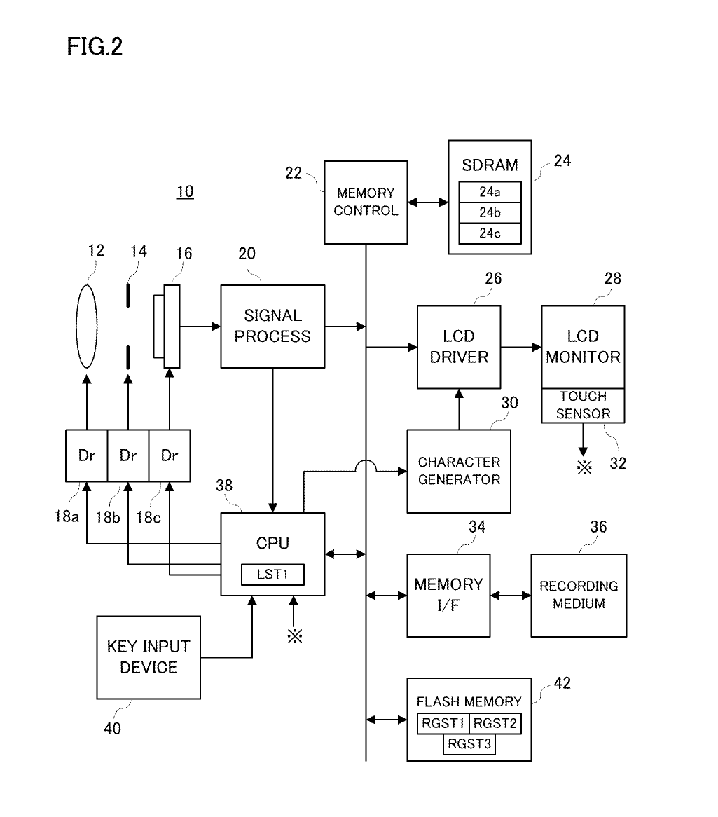

With reference to FIG. 2, a digital camera 10 according to one embodiment includes a focus lens 12 and an aperture unit 14 driven by drivers 18a to 18c, respectively. An optical image that underwent these components enters, with irradiation, an imaging surface of an imager 16, and is subjected to a photoelectric conversion.

When a camera mode is selected, in order to execute a moving-image taking process, a CPU 38 commands the driver 18c to repeat an exposure procedure and a electric-charge reading-out procedure. In response to a vertical synchronization signal Vsync periodically generated, the driver 18c exposes the imaging surface of the imager 16 and reads out the electric charges produced on the imaging surface in a raster scanning manner. From the imager 16, raw image data that is based on the read-out electric charges is cyclically outputted.

A signal processing circuit 20 performs processes such as a white balance adjustment, a color separation, and a YUV conversion on the raw image data outputted from the imager 16. YUV-formatted image data generated thereby is written into a YUV image area 24a of an SDRAM 24 through a memory control circuit 22. An LCD driver 26 repeatedly reads out the image data stored in the YUV image area 24a through the memory control circuit 22, and drives an LCD monitor 28 based on the read-out image data. As a result, a real-time moving image (live view image) representing a scene captured on the imaging surface is displayed on a monitor screen.

Moreover, the signal processing circuit 20 applies Y data forming the image data to the CPU 38. The CPU 38 performs a simple AE process on the applied Y data so as to calculate an appropriate EV value and set an aperture amount and an exposure time period that define the calculated appropriate EV value to the drivers 18b and 18c, respectively. Thereby, the raw image data outputted from the imager 16, by extension, a brightness of a live view image displayed on the LCD monitor 28 is adjusted approximately.

When a recording operation is performed toward a key input device 40, the CPU 38 performs a strict AE process on the Y data applied from the signal processing circuit 20 so as to calculate an optimal EV value. Aperture amount and an exposure time period that define the calculated optimal EV value are set to the drivers 18b and 18c, respectively. Moreover, the CPU 38 performs an AF process on a high-frequency component of the Y data applied from the signal processing circuit 20. Thereby, the focus lens 12 is placed at a focal point.

Upon completion of the AF process, the CPU 38 executes a still-image taking process, and concurrently, commands a memory I/F 34 to execute a recording process. Image data representing a scene at a time point at which the AF process is completed is evacuated from the YUV image area 24a to a still-image area 24b by the still-image taking process. The memory I/F 34 commanded to execute the recording process reads out the image data evacuated to the still-image area 24b through the memory control circuit 22 so as to record an image file containing the read-out image data on a recording medium 36.

When a reproducing mode is selected, the CPU 38 designates the latest image file recorded in the recording medium 36, and commands the memory I/F 34 and the LCD driver 26 to execute a reproducing process in which the designated image file is noticed. The memory I/F 34 reads out image data of the designated image file from the recording medium 36 so as to write the read-out image data into the still-image area 24b of the SDRAM 24 through the memory control circuit 22.

The LCD driver 26 reads out the image data stored in the still-image area 24b through the memory control circuit 22, and drives the LCD monitor 28 based on the read-out image data. As a result, a reproduced image that is based on the image data of the designated image file is displayed on the LCD monitor 28. When a forward/backward operation is performed toward the key input device 40, the CPU 38 designates a succeeding image file or a preceding image file. The designated image file is subjected to the reproducing process similar to that described above and as a result, the reproduced image is updated.

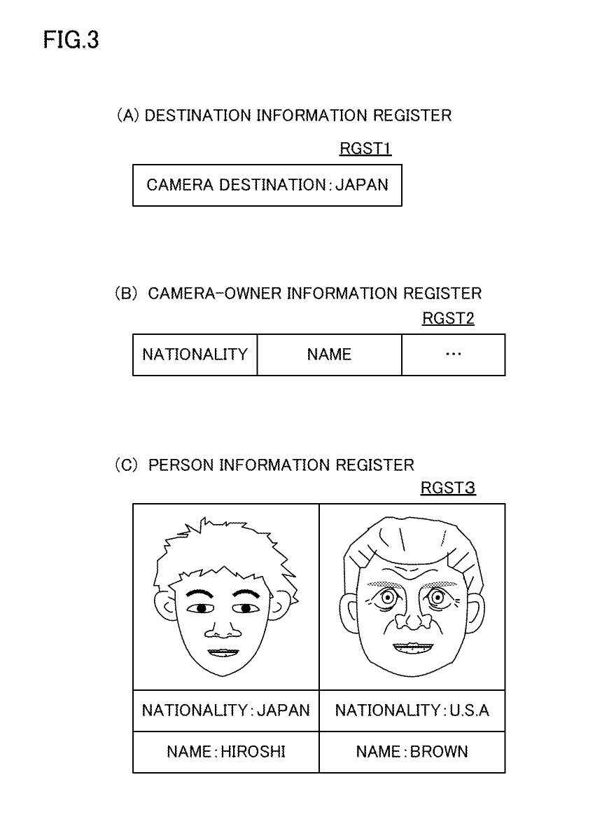

It is noted that, as an assumption of the process in the reproducing mode, a destination information register RGST1 shown in FIG. 3(A), a camera-owner information register RGST2 shown in FIG. 3(B) and a person information register RGST3 shown in FIG. 3(C) are prepared in a flash memory 42.

In the destination information register RGST1, information indicating a destination (=a country name) of the digital camera 10 is initially registered. In the camera-owner information register RGST2, person information of a camera owner such as a nationality, a name and etc. is registered by a user operation. In the person information register RGST3, person information related to a desired person such as a characteristic amount of a face image, a nationality, a name and etc. is registered by the user operation.

When an image extracting operation is performed toward the key input device 40 in a state where the reproducing mode is selected, on the condition that one or at least two names of persons are registered in the person information register RGST3, the CPU 38 commands a character generator 30 to display a person-information menu in which the names of these persons are listed.

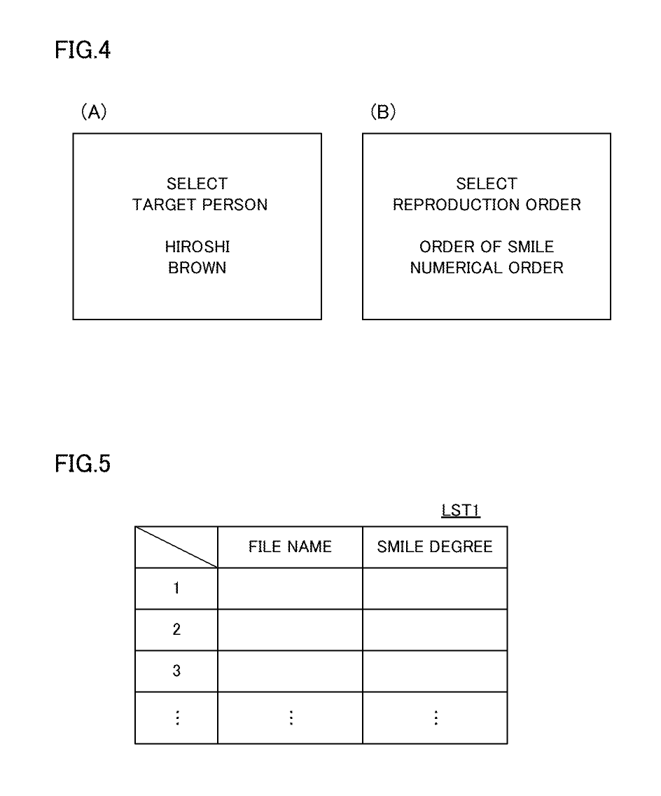

The character generator 30 applies character data that comply with the command to the LCD driver 26, and the LCD driver 26 drives the LCD monitor 28 based on the applied character data. As a result, a registered-person menu is displayed on the monitor screen as shown in FIG. 4(A).

A touch operation to the monitor screen is detected by a touch sensor 32, and a detected result is applied to the CPU 38. When one of the names listed in the registered-person menu is touched, it is regarded that a target person is selected. In response to the touch operation, the CPU 38 commands the character generator 30 to display a reproduction-order menu. The character generator 30 applies character data that comply with the command to the LCD driver 26, and the LCD driver 26 drives the LCD monitor 28 based on the applied character data. As a result, the reproduction-order menu is displayed on the monitor screen as shown in FIG. 4(B).

When “order of smile” of the reproduction-order menu is touched, the CPU 38 sets race information of the camera owner and race information of the target person in a following manner.

When the nationality of the camera owner is registered in the camera-owner information register RGST2, the race information of the camera owner is set based on the registered nationality. On the other hand, when the nationality of the camera owner is not registered in the camera-owner information register RGST2, the race information of the camera owner is set based on the country name registered in the destination information register RGST1. Moreover, when the nationality of the target person is registered in the person information register RGST3, the race information of the target person is set based on the registered nationality. On the other hand, when the nationality of the target person is not registered in the person information register RGST3, information same as the race information of the camera owner is set as the race information of the target person. The race information thus set indicates any one of “Caucasoid”, “Negroid”, “Australoid” and “Mongoloid”.

It is noted that, when “numerical order” is touched on the reproduction-order menu, a race-information setting process described above is omitted.

Subsequently, the CPU 38 reads out from the recording medium 36 the image data contained in one or at least two image file in the recording medium 36 through the memory I/F 34 so as to expand the read-out image data in a work area 24c of the SDRAM 24 through the memory control circuit 22. Furthermore, the CPU 38 detects a characteristic amount of the face image of the target person from the person information register RGST3, and searches for a face image having a characteristic amount in which a matching degree to the detected characteristic amount exceeding a reference, from the image data expanded in the work area 24c.

When the face image of a search target is detected, the CPU 38 performs a smile-degree estimating process on the detected face image so as to register a smile degree calculated thereby on a search list LST1 shown in FIG. 5 together with a file name of an image file containing image data of the search target. One or at least two file names registered in the search list LST1 are sorted in descending order of the smile degree after the above-described process to all of the image files is completed.

The smile-degree estimating process is executed in a following manner. Firstly, a characteristic amount of an eyes region of the target person is detected so as to calculate a smile degree based on the detected characteristic amount. The calculated smile degree is set to a variable Veyes. Subsequently, a characteristic amount of a mouth region of the target person is detected so as to calculate a smile degree based on the detected characteristic amount. The calculated smile degree is set to a variable Vmouth. Furthermore, weighted amounts αe and αm are determined with reference to the race information of the camera owner, and weighted amounts βe and βm are determined with reference to the race information of the target person.

When the race information of the camera owner is the “Mongoloid”, the weighted amounts αe and αm are determined so that a relationship of the equation αe>αm is established. When the race information of the camera owner is the “Caucasoid”, the “Negroid” or the “Australoid”, the weighted amounts αe and αm are determined so that a relationship of the equation αe<αm is established.

Similarly, when the race information of the target person is the “Mongoloid”, the weighted amounts βe and βm are determined so that a relationship of the equation βe>βm is established. When the race information of the target person is the “Caucasoid”, the “Negroid” or the “Australoid”, the weighted amounts βe and βm are determined so that a relationship of the equation βe<βm is established.

A determining process for the above-described weighted amounts is based on a fact that Asians tend to interpret an expression of a face based on a shape of eyes whereas Westerners tend to interpret the expression of the face based on a shape of a mouth.

The smile degree is calculated by applying the smile degrees Veyes and Vmouth and the weighted amounts αe, αm, βe and βm thus calculated or determined to Equation 1.

Smile degree=[αe*Veyes+αm*Vmouth]*Wα+[βe*Veyes+βm*Vmouth]*Wβ [Equation 1]

Wα: constant
Wβ: constant

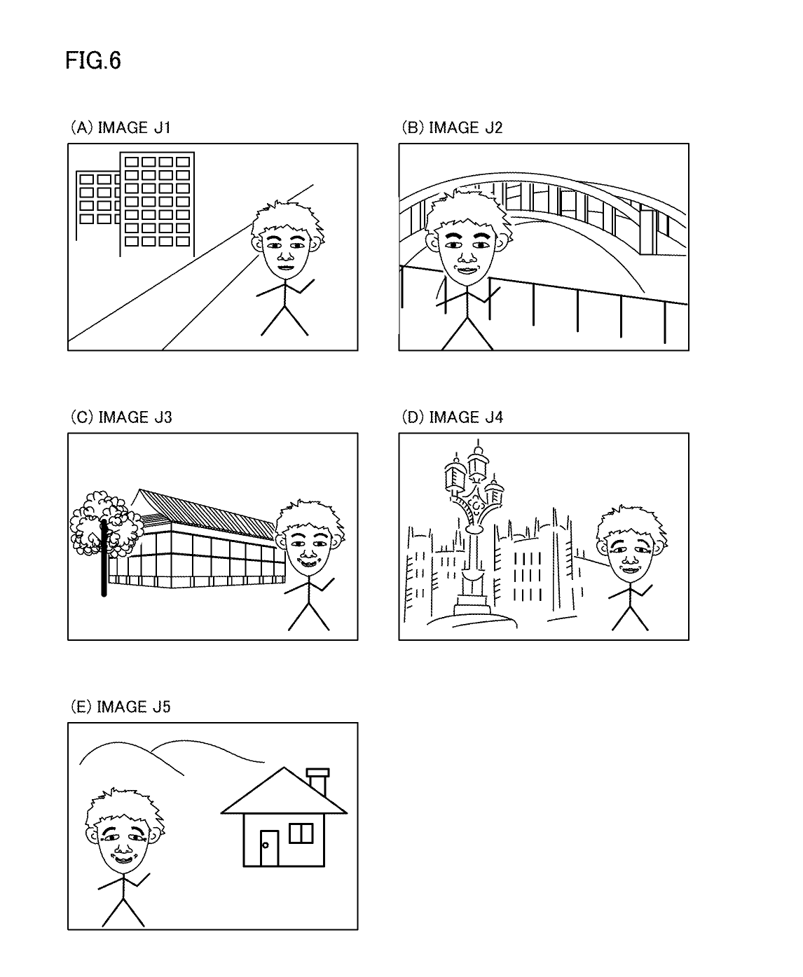

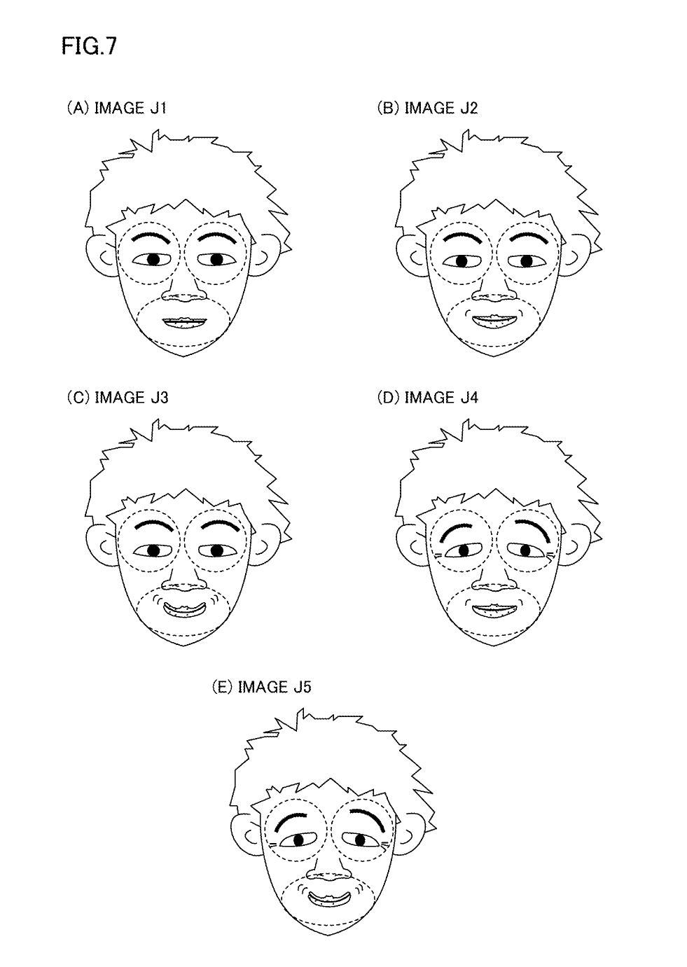

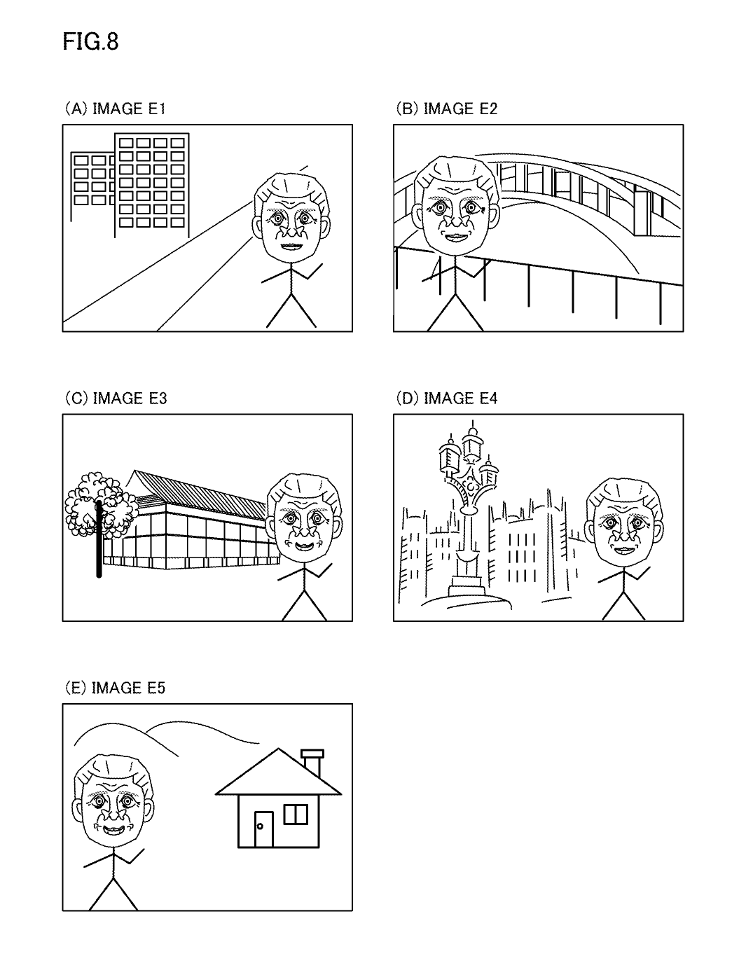

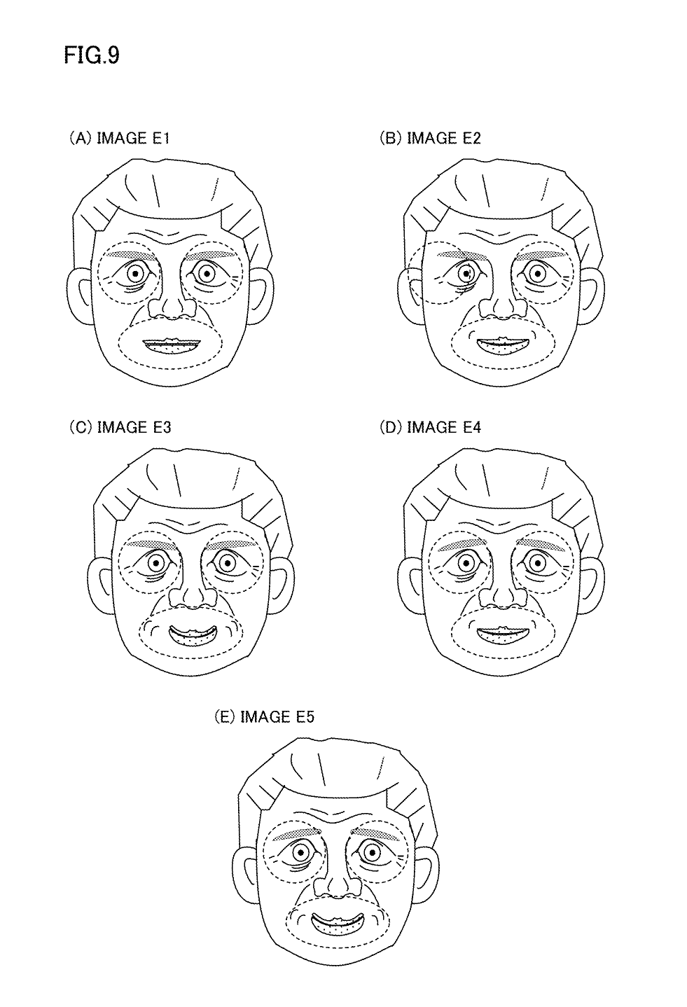

It is assumed that an image file containing image data J1 to J5 shown in FIG. 6(A) to FIG. 6(E) and an image file containing image data E1 to E5 shown in FIG. 8(A) to FIG. 8(E) are recorded on the recording medium 36. Here, five face images appeared in the image data J1 to J5 respectively have expressions shown in FIG. 7(A) to FIG. 7(E), and five face images appeared in the image data E1 to E5 respectively have expressions shown in FIG. 9(A) to FIG. 9(E).

According to FIG. 7(A) to FIG. 7(E), regarding the eyes region, a deformation amount of the image J1, a deformation amount of the image J2 and a deformation amount of the image J3 are closely matched each other, while the deformation amount is decreased in the order of the image J5, the image J4, the image J3, the image J2 and the image J1. In contrary, regarding the mouth region, the deformation amount of the image J3 and the deformation amount of the image J5 are closely matched each other, and the deformation amount of the image J2 and the deformation amount of the image J4 are closely matched each other, while the deformation amount is decreased in the order of the image J5, the image J4, the image J3, the image J2 and the image J1.

According to FIG. 9(A) to FIG. 9(E), regarding the eyes region, a deformation amount of the image E1, a deformation amount of the image E2 and a deformation amount of the image E3 are closely matched each other, and the deformation amount of the image E4 and the deformation amount of the image E5 are closely matched each other, while the deformation amount is decreased in the order of the image E5, the image E4, the image E3, the image E2 and the image E1. In contrary, regarding the mouth region, the deformation amount of the image E3 and the deformation amount of the image E5 are closely matched each other, and the deformation amount of the image E2 and the deformation amount of the image E4 are closely matched each other, while the deformation amount is decreased in the order of the image E5, the image E4, the image E3, the image E2 and the image E1.

Based on this, when the nationality registered in the camera-owner information register RGST2 indicates “Japan”, a name “Hiroshi” is selected on the registered-person menu, and the “order of smile” is selected on the reproduction-order menu, the file names registered in the search list LST1 are sorted in the order of the image J5, the image J4, the image J3, the image J2 and the image J1. The deformation amount of the eyes region is strongly reflected to the sorted order than the deformation amount of the mouth region.

Moreover, when the nationality registered in the camera-owner information register RGST2 indicates “the United States of America”, a name “Brown” is selected on the registered-person menu, and the “order of smile” is selected on the reproduction-order menu, the file names registered in the search list LST1 are sorted in the order of the image E5, the image E3, the image E4, the image E2 and the image E1. The deformation amount of the mouth region is strongly reflected to the sorted order than the deformation amount of the eyes region.

It is noted that, when the “numerical order” is selected on the reproduction-order menu, a smile degree “0” is registered on the search list LST1 together with the file name of the image file containing the image data of the search target. Moreover, sorting the file names registered in the search list LST1 is omitted.

Thereafter, the CPU 38 designates an image file having a file name described in a head column of the search list LST1 so as to execute a reproducing process in which the designated image file is noticed. As a result, a reproduced image is displayed on the LCD monitor 28.

When a forward/backward operation is performed toward the key input device 40, the CPU 38 designates an image file having a file name described in a subsequent column or a prior column of the search list LST1 so as to execute a reproducing process in which the designated image file is noticed. As a result, the reproduced image is updated.

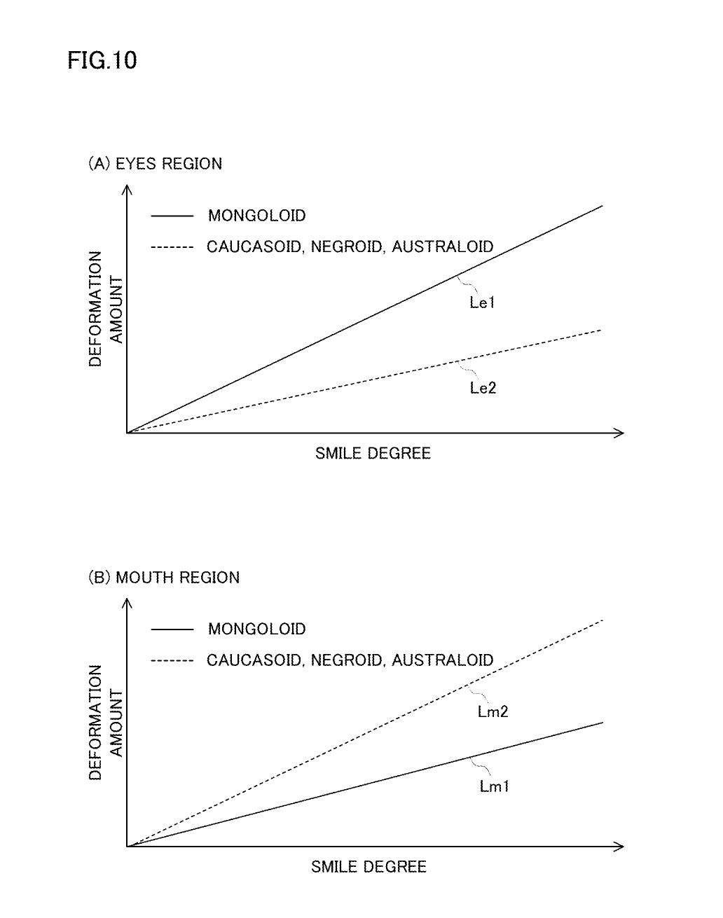

When a smile-degree designating operation is performed toward the key input device 40, the CPU 38 deforms the face image of the target person appeared in the reproduced image with reference to the designated smile degree. An image deforming process is executed in a following manner with reference to two smile-transformation functions respectively equivalent to two straight lines Le1 and Le2 shown in FIG. 10(A) and two smile-transformation functions respectively equivalent to two straight lines Lm1 and Lm2 shown in FIG. 10(B). It is noted that the two smile-transformation functions shown in FIG. 10(A) are corresponding to the eyes region, and the two smile-transformation functions shown in FIG. 10(B) are corresponding to the mouth region.

Firstly, a smile-transformation function corresponding to the race information of the camera owner is selected from among the two smile-transformation functions shown in FIG. 10 (A), and is selected from among the two smile-transformation functions shown in FIG. 10(B). Similarly, a smile-transformation function corresponding to the race information of the target person is selected from among the two smile-transformation functions shown in FIG. 10(A), and is selected from among the two smile-transformation functions shown in FIG. 10(B).

The two smile-transformation functions specified regarding the eyes region are subjected to a weighting operation referring to the race information of the camera owner and the race information of the target person. Moreover, the two smile-transformation functions specified regarding the mouth region are subjected to the weighting operation referring to the race information of the camera owner and the race information of the target person. Thereby, a single smile-transformation function regarding the eyes region and a single smile-transformation function regarding the mouth region are acquired.

Subsequently, a smile-deformation amount of the eyes region corresponding to the designated smile degree is calculated with reference to the smile-transformation function of the eyes region, and a smile-deformation amount of the mouth region corresponding to the designated smile degree is calculated with reference to the smile-transformation function of the mouth region. The image data on the still-image area 24a is modified so that the face image of the target person is deformed according to the smile-deformation amount thus calculated. A reproduced image that is based on the modified image data is displayed on the LCD monitor 28.

Thus, when both of the race information of the camera owner and the race information of the target person are the “Mongoloid”, the face image is deformed with reference to the straight lines Le1 and Lm1 shown in FIG. 10(A) and FIG. 10(B). The deformation amount of the eyes region becomes greater than the deformation amount of the mouth region. In contrary, when both of the race information of the camera owner and the race information of the target person are the “Caucasoid”, the face image is deformed with reference to the straight lines Le2 and Lm2 shown in FIG. 10(A) and FIG. 10(B). The deformation amount of the eyes region becomes smaller than the deformation amount of the mouth region.

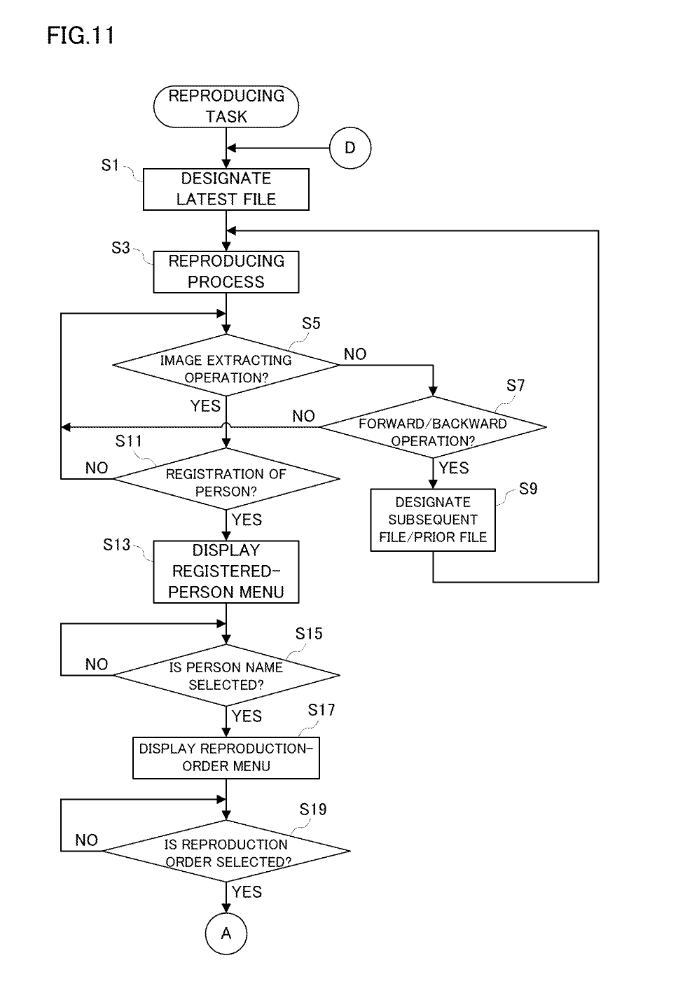

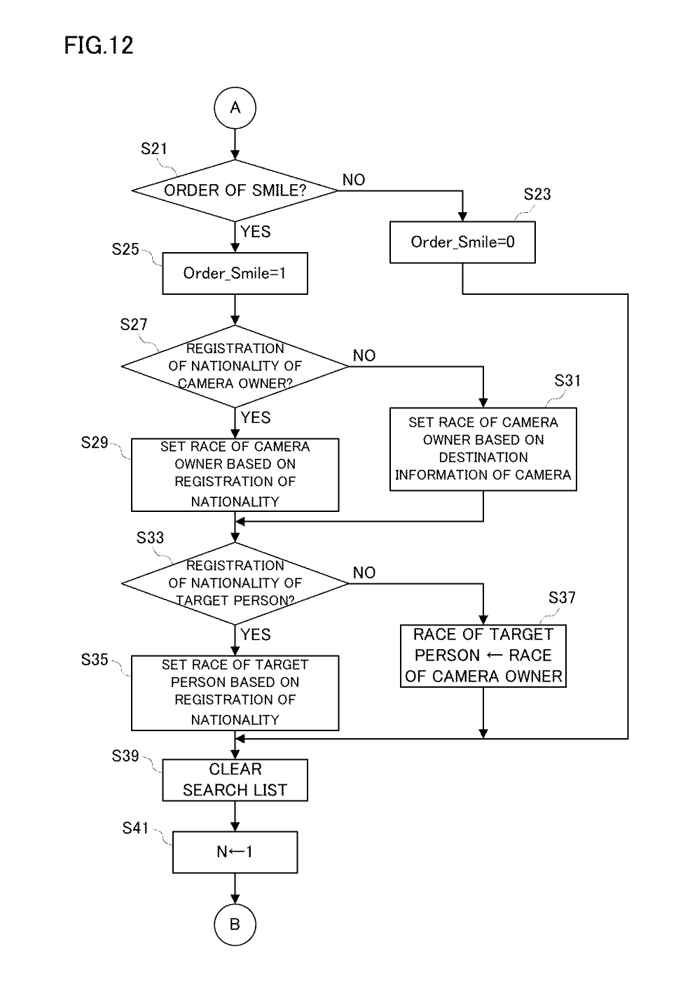

When the reproducing mode is selected, the CPU 38 executes a reproducing task shown in FIG. 11 to FIG. 17. It is noted that the CPU 38 is a CPU which executes a plurality of tasks on a multi task operating system such as the μITRON, in a parallel manner. It is noted that control programs equivalent to the tasks executed by the CPU 38 are stored in the flash memory 42.

With reference to FIG. 11, in a step S1, the latest image file recorded in the recording medium 36 is designated, and in a step S3, the memory I/F 34 and the LCD driver 26 are commanded to execute a reproducing process in which the designated image file is noticed.

The memory I/F 34 reads out image data of the designated image file from the recording medium 36 so as to write the read-out image data into the still-image area 24b of the SDRAM 24 through the memory control circuit 22. The LCD driver 26 reads out the image data stored in the still-image area 24b through the memory control circuit 22, and drives the LCD monitor 28 based on the read-out image data. As a result, a reproduced image is displayed on the LCD monitor 28.

In a step S5, it is determined whether or not the image extracting operation is performed, and in a step S7, it is determined whether or not the forward/backward operation is performed. When a determined result of the step S7 is YES, the process advances to a step S9 so as to designate the subsequent image file or the prior image file recorded in the recording medium 36. Upon completion of the designating process, the process returns to the step S3. As a result, another reproduced image is displayed on the LCD monitor 28.

When a determined result of the step S5 is YES, the process advances to a step S11 so as to determine whether or not one or at least two persons are registered in the person information register RGST3. When a determined result is NO, the process returns to the step S5. In contrary, when the determined result is YES, one or at least two names of the persons registered in the person information register RGST3 are detected, and the character generator 30 is commanded to display the person-information menu in which the detected names of the persons are listed.

The character generator 30 applies character data that comply with the command to the LCD driver 26, and the LCD driver 26 drives the LCD monitor 28 based on the applied character data. As a result, the registered-person menu is displayed on the monitor screen as shown in FIG. 4(A).

In a step S15, it is determined based on output of the touch sensor 32 whether or not the target person is selected. When a determined result is updated from NO to YES, the process advances to a step S17, and the character generator 30 is commanded to display the reproduction-order menu. The character generator 30 applies character data that comply with the command to the LCD driver 26, and the LCD driver 26 drives the LCD monitor 28 based on the applied character data. As a result, the reproduction-order menu is displayed on the monitor screen as shown in FIG. 4(B).

In a step S19, it is determined based on output of the touch sensor 32 whether or not a reproduction order is selected, and when a determined result is YES, in a step S21, it is determined whether the selected order is either the “order of smile” or “numerical order”. When the selected order is the “numerical order”, in a step S23, a variable Order_Smile is set to “0”, and thereafter, the process advances to a step S39. In contrary, when the selected order is the “order of smile”, in a step S25, the variable Order_Smile is set to “1”, and the process advances to the step S39 after executing processes in steps S27 to S37.

In the step S27, it is determined whether or not the nationality of the camera owner is registered in the camera-owner information register RGST2. When a determined result is YES, the process advances to the step S29 so as to set the race information of the camera owner based on the registered nationality. On the other hand, when the determined result is NO, the process advances to the step S31 so as to set the race information of the camera owner based on the country name registered in the destination information register RGST1.

In the step S33, it is determined whether or not the nationality of the target person selected on the registered-person menu is registered in the person information register RGST3. When a determined result is YES, the process advances to the step S35 so as to set the race information of the target person based on the registered nationality. On the other hand, when the determined result is NO, the process advances to the step S37 so as to set information same as the race information of the camera owner as the race information of the target person.

The race information thus set indicates any one of the “Caucasoid”, the “Negroid”, the “Australoid” and the “Mongoloid”.

In the step S39, the search list LST1 is cleared, and in a step S41, a variable N is set to “1”. In a step S43, image data contained in an N-th image file is read out from the recording medium 36 through the memory I/F 34 so as to expand the read-out image data in the work area 24c of the SDRAM 24 through the memory control circuit 22.

In a step S45, a characteristic amount of the face image of the target person is detected from the person information register RGST3, and a face image having a characteristic amount in which a matching degree to the detected characteristic amount exceeding a reference is searched from the image data expanded in the work area 24c. In a step S47, it is determined whether or not the face image of a search target is detected, and when a determined result is NO, the process directly advances to a step S57 whereas when the determined result is YES, the process advances to the step S57 via processes in steps S49 to S55.

In the step S46, it is determined whether or not the variable Order_Smile indicates “1”, and when a determined result is YES, in the step S51, the smile-degree estimating process is executed whereas when the determined result is NO, in the step S53, the smile degree is set to “0”. In the step S55, a file name of the N-th image file and the smile degree acquired by the process in the step S51 or S53 are registered in the search list LST1.

In the step S57, it is determined whether or not the variable N has reached a maximum value Nmax (=the total number of the image files). When a determined result is NO, in a step S59, the variable N is incremented, and thereafter, the process returns to the step S43 whereas when the determined result is YES, the process advances to a step S61.

In the step S61, it is determined whether or not the variable Order_Smile indicates “1”, and when a determined result is NO, the process directly advances to a step S65 whereas when the determined result is YES, the process advances to the step S65 via a process in a step S63. In the step S63, one or at least two file names registered in the search list LST1 are sorted in descending order of the smile degree.

In the step S65, an image file having a name described in a head column of the search list LST1 is designated, and in a step S67, the reproducing process in which the designated image file is noticed is executed in the same manner as in the step S3. As a result, a reproduced image is displayed on the LCD monitor 28. In a step S69, it is determined whether or not an ending operation is performed, and in a step S71, it is determined whether or not the forward/backward operation is performed, and in a step S77, it is determined whether or not the smile-degree designating operation is performed. When the determined result of the step S69 is YES, the process returns to the step S1, and when a determined result of the step S71 is YES, the process advances to the step S73. When a determined result of the step S77 is YES, the process advances to a step S79.

In the step S73, an image file having a file name described in a subsequent column or a prior column of the search list LST1 is designated, and in a step S75, the reproducing process in which the designated image file is noticed in the same manner as in the step S3. As a result, the reproduced image is updated. Upon completion of the process in the step S75, the process returns to the step S69. In the step S79, the face image of the target person appeared in the reproduced image is deformed with reference to the designated smile degree. Upon completion of the deforming process, the process returns to the step S69.

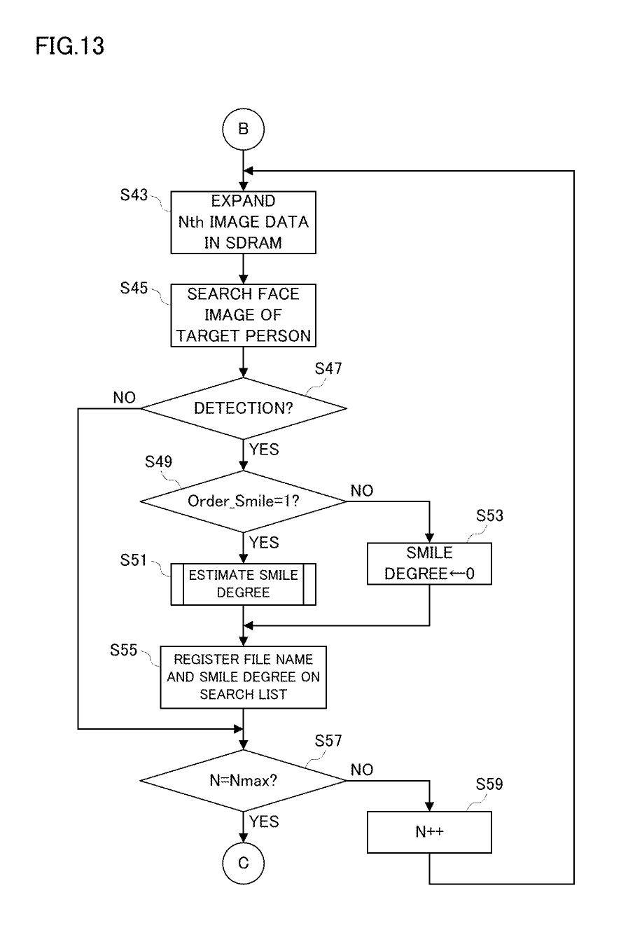

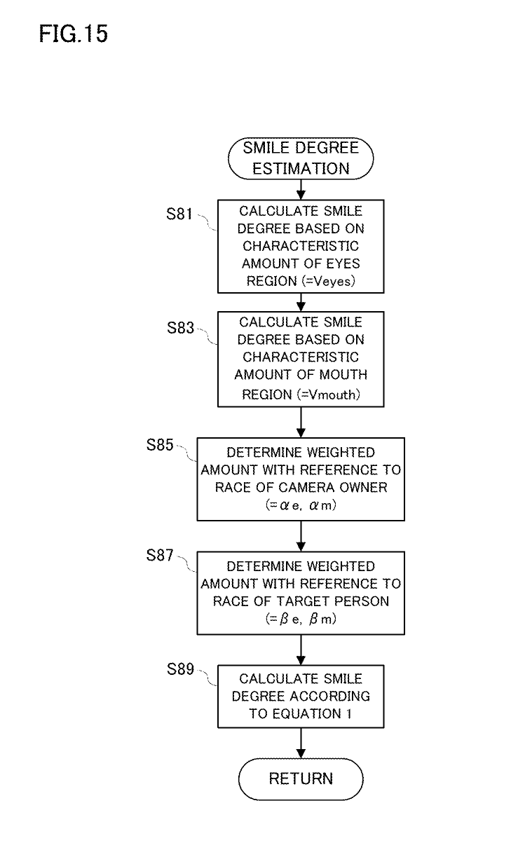

The smile-degree estimating process in the step S51 shown in FIG. 13 is executed according to a subroutine shown in FIG. 15. In a step S81, a characteristic amount of an eyes region of the target person is detected so as to calculate a smile degree based on the detected characteristic amount. The calculated smile degree is set to the variable Veyes. In a step S83, a characteristic amount of a mouth region of the target person is detected so as to calculate a smile degree based on the detected characteristic amount. The calculated smile degree is set to the variable Vmouth.

In a step S85, the weighted amounts αe and αm are determined with reference to the race information of the camera owner set in the step S29 or S31. In a step S87, the weighted amounts βe and βm are determined with reference to the race information of the target person set in the step S35 or S37. In a step S89, the smile degree is calculated by applying the smile degrees Veyes and Vmouth and the weighted amounts αe, αm, βe and βm thus calculated or determined to Equation 1 described above.

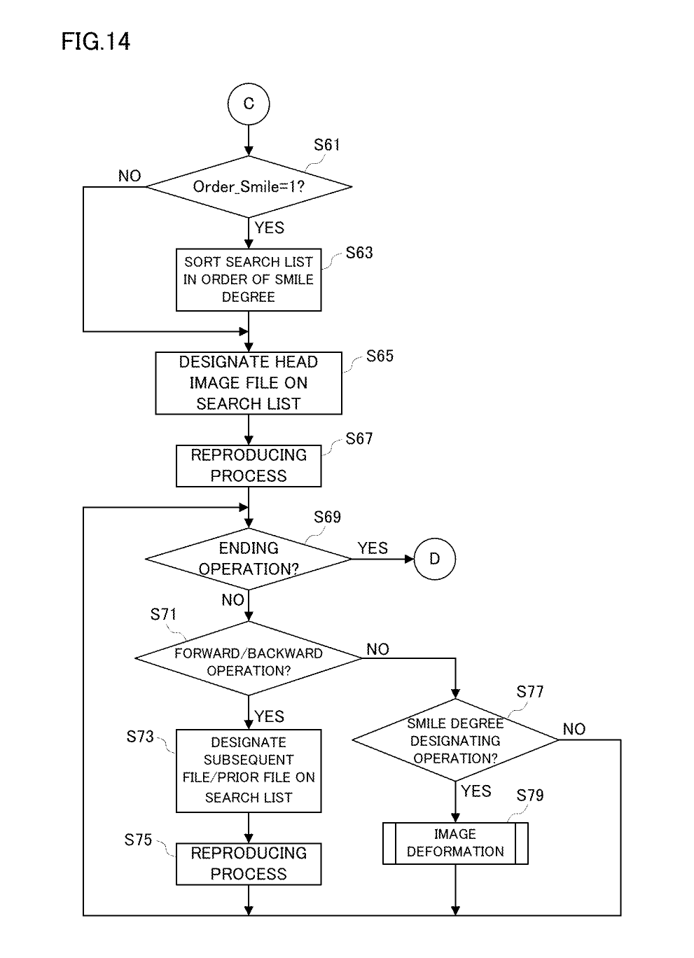

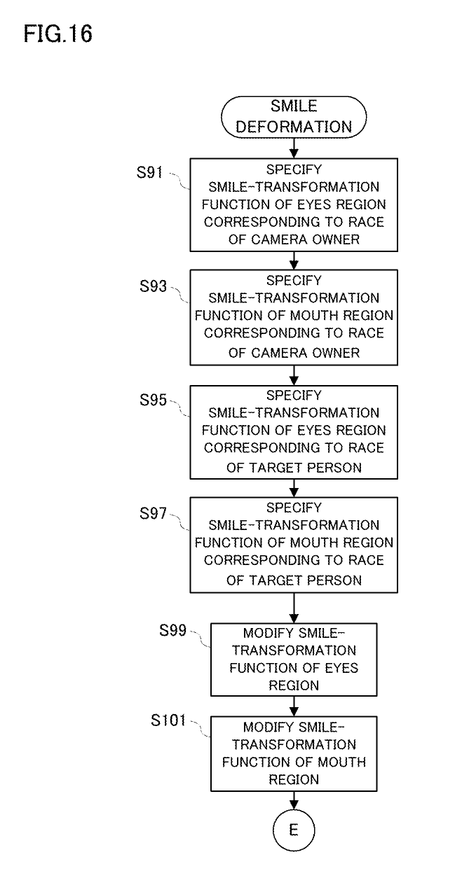

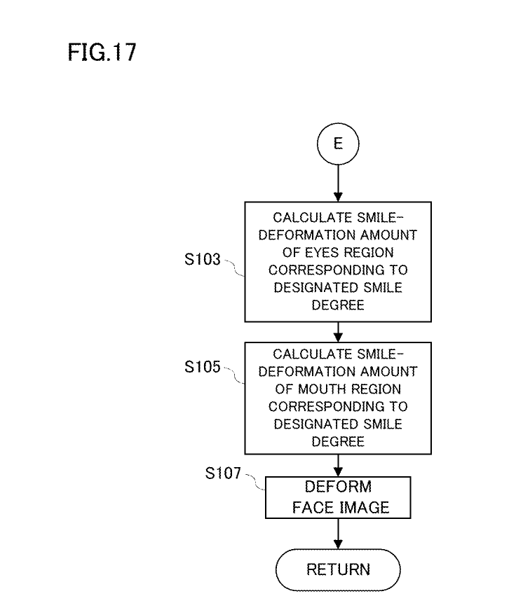

The image deforming process in the step S79 shown in FIG. 14 is executed according to a subroutine shown in FIG. 16 to FIG. 17. In a step S91, a smile-transformation function of the eyes region corresponding to the race information of the camera owner is specified, and in a step S93, a smile-transformation function of the mouth region corresponding to the race information of the camera owner is specified. In a step S95, a smile-transformation function of the eyes region corresponding to the race information of the target person is specified, and in a step S97, a smile-transformation function of the mouth region corresponding to the race information of the target person is specified.

In a step S99, the smile-transformation function specified in the step S91 and the smile-transformation function specified in the step S95 are subjected to the weighting operation referring to the race information of the camera owner and the race information of the target person so as to calculate a single smile-transformation function regarding the eyes region. In a step S101, the smile-transformation function specified in the step S93 and the smile-transformation function specified in the step S97 are subjected to the weighting operation referring to the race information of the camera owner and the race information of the target person so as to calculate a single smile-transformation function regarding the mouth region.

In a step S103, a smile-deformation amount of the eyes region corresponding to the designated smile degree is calculated with reference to the smile-transformation function modified in the step S99. In a step S105, a smile-deformation amount of the mouth region corresponding to the designated smile degree is calculated with reference to the smile-transformation function modified in the step S101. In a step S107, the image data on the still-image area 24a is modified so that the face image of the target person is deformed according to the smile-deformation amount thus calculated.

As can be seen from the above-described explanation, when the image extracting operation is performed toward the key input device 40, the CPU 38 searches for the face image representing the face portion of the target person from the designated image (S43 to S45), and defines the expression of the face image in a manner different depending on the race of the target person and/or a race of the camera owner (=the operator) (S51, S77, S91 to S105). Furthermore, the CPU 38 performs on the designated image the output process different depending on the defined expression (S55, S63 to S67, S71 to S75, S107).

When the expression of the face of the target person is changed corresponding to emotions of the target person, the manner of the change is different depending on the race of the target person. Moreover, the emotions of the target person received from the change of the expression of the face by the observer who observes the target person are different depending on the race of the observer.

Then, in this embodiment, the expression of the face image of the target person is defined in the manner different depending on the race of the target person and/or the race of the camera owner, and the output process different depending on the defined expression is performed on the designated image. Thereby, the image output performance is improved.

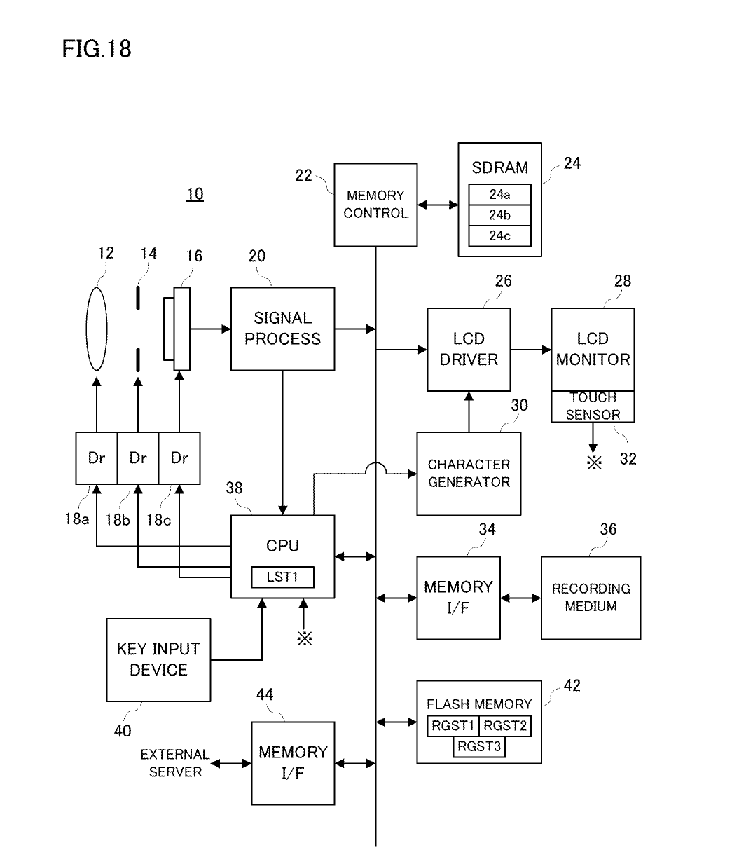

It is noted that, in this embodiment, the control programs equivalent to the multi task operating system and the plurality of tasks executed thereby are previously stored in the flash memory 42. However, a communication I/F 44 may be arranged in the digital camera 10 as shown in FIG. 18 so as to initially prepare a part of the control programs in the flash memory 42 as an internal control program whereas acquire another part of the control programs from an external server as an external control program. In this case, the above-described procedures are realized in cooperation with the internal control program and the external control program.

Moreover, in this embodiment, the processes executed by the CPU 38 are divided into a plurality of tasks in a manner described above. However, these tasks may be further divided into a plurality of small tasks, and furthermore, a part of the divided plurality of small tasks may be integrated into another task. Moreover, when each of tasks is divided into the plurality of small tasks, the whole task or a part of the task may be acquired from the external server.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An image processing apparatus comprising:
a searcher which searches for a face image representing a face portion of a target person from a designated image, in response to an operation of an operator;
a definer which defines an expression of the face image detected by said searcher in a manner different depending on a race of the target person and/or a race of the operator; and
a processor which performs on the designated image an output process different depending on the expression defined by said definer.

2. An image processing apparatus according to claim 1, wherein said definer includes an arithmetic processor which performs on a characteristic amount of a plurality of parts forming the face image detected by said searcher a weighting operation different depending on the race of the target person and/or the race of the operator, and said processor includes an image outputter which executes, corresponding to a detection of said searcher, a process of outputting the designated image in a manner different depending on a magnitude of an arithmetic value calculated by said arithmetic processor.

3. An image processing apparatus according to claim 2, wherein said image outputter includes an assigner which assigns a priority according to the magnitude of the arithmetic value to the designated image.

4. An image processing apparatus according to claim 2, further comprising a designator which designates, for a process of said searcher, each of a plurality of images recorded on a recording medium, wherein said image outputter includes a reproducer which reproduces the designated image in order according to the priority assigned by said assinger.

5. An image processing apparatus according to claim 1, wherein said definer includes an acquirer which acquires a transformation function corresponding to the race of the target person and/or the race of the operator, based on a plurality of transformation functions respectively corresponding to a plurality of races, and said processor includes a modifier which modifies the designated image so that the face image detected by said searcher is deformed with reference to the transformation function acquired by said acquirer.

6. An image processing apparatus according to claim 5, wherein the transformation function acquired by said acquirer is equivalent to a function indicating a relationship between a smile degree and a deformation degree, said definer further includes an inputter which inputs a desired smile degree and a deformation-degree calculator which calculates, based on the transformation function, a deformation degree corresponding to the smile degree inputted by said inputter, and said modifier deforms the face image according to the deformation degree calculated by said calculator.

7. An image processing program recorded on a non-transitory recording medium in order to control an image processing apparatus, the program causing a processor of the image processing apparatus to perform the steps comprises:
a searching step of searching for a face image representing a face portion of a target person from a designated image, in response to an operation of an operator;
a defining step of defining an expression of the face image detected by said searching step in a manner different depending on a race of the target person and/or a race of the operator; and
a processing step of performing on the designated image an output process different depending on the expression defined by said defining step.

8. An image processing method executed by an image processing apparatus, comprising:
a searching step of searching for a face image representing a face portion of a target person from a designated image, in response to an operation of an operator;
a defining step of defining an expression of the face image detected by said searching step in a manner different depending on a race of the target person and/or a race of the operator; and
a processing step of performing on the designated image an output process different depending on the expression defined by said defining step.
